(19) United States
(12) Patent Application Publication
(10) Pub. No.: US 2011/0316357 A1
(43) Pub. Date: Dec. 29, 2011

(54) STATOR PACKET FOR A MAGNETIC LEVITATION TRAIN

(76) Inventor: Juergen Braun, Neustetten (DE)

(21) Appl. No.: 13/132,986

(22) PCT Filed: Dec. 2, 2009
(86) PCT No.: PCT/EP09/08569

§ 371 Date: Aug. 2, 2011

(30) Foreign Application Priority Data
Dec. 8, 2008 (DE) 10 2008 061 004.6

(51) Int. Cl. H02K 41/02

(52) U.S. Cl. 310/12.09; 310/12.26

(57) ABSTRACT

The invention relates to a stator packet for a long stator linear motor of a magnetic levitation train. The stator packet is composed of a plurality of sheet metal layers (6) comprising alternating grooves (7) and teeth (8) for receiving alternating-current windings (20). The grooves (7) are configured so that the windings (20) can be pressed into the same and retained therein without additional auxiliary means. According to the invention, the grooves (7) and teeth (8) are congruent, have centrally symmetrical side walls (12, 14), and are coated only with a thin corrosion protection coating that changes the shape of the teeth and grooves only insignificantly.

The invention relates to a stator packet of the generic type described in the preamble to claim 1.

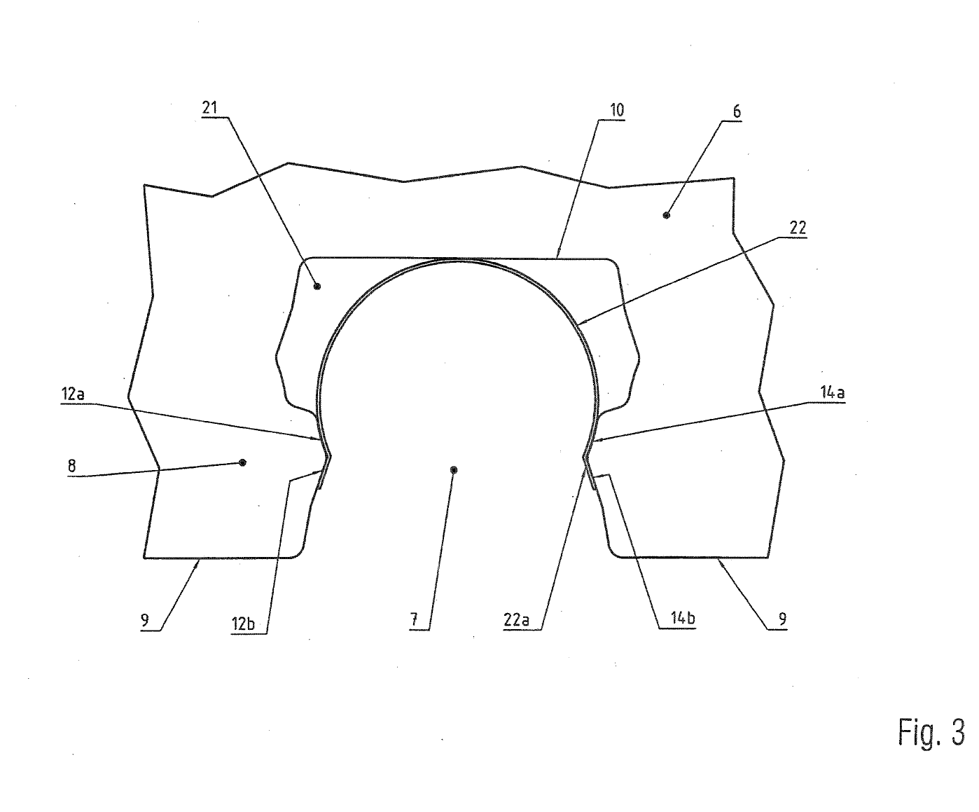

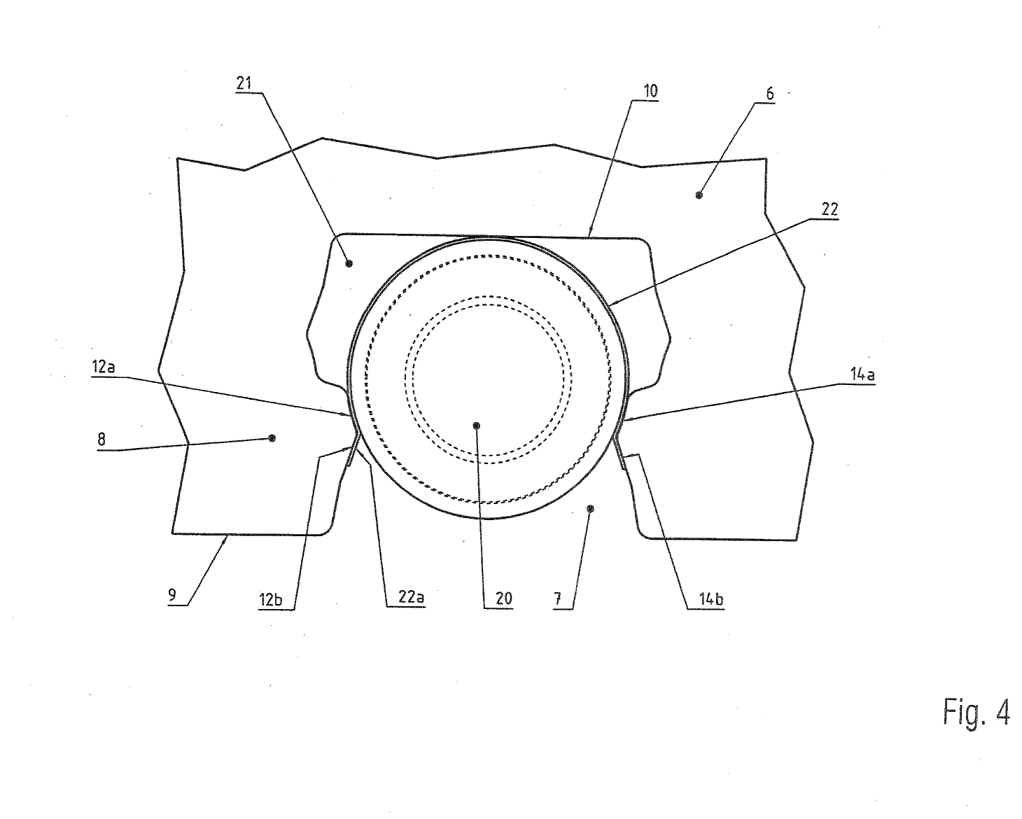

Stator packets for magnetic levitation trains are composed of a plurality of sheet metal plates, which are provided with a series of teeth and grooves into which traveling field windings are inserted. For this purpose, known stator packets of the generic type mentioned at the beginning (DE 196 20 221 A1, FIGS. 3 and 4) are provided, for example, with plates whose grooves are stamped to give them an inner contour that is adapted to the cylindrical outer contour of the windings. An advantage of such stator packets lies in the fact that the windings, due to their elastic outer casing, can be pressed into the grooves in a fashion similar to snap connections and then secured in them without additional accessories. A disadvantage therein, however, is that the manufacture of the plates by stamping or the like inevitably leads to a comparatively large amount of waste (scrap). In addition, there are already known stator packets whose plates have congruently embodied teeth and grooves (DE 33 09 051 C2) that largely circumvent the problem of excessive waste. However, this is achieved at the cost of the disadvantage that the windings cannot be pressed into the grooves in a fashion similar to snap connections, but must instead be secured in them with the aid of additional holding elements.

The stator packets in actual use in the field of magnetic levitation trains are therefore composed of sheet metal plates whose grooves have larger cross-sections than the windings. To nevertheless permit the windings to be pressed into the grooves in a fashion similar to a snap connection, after the manufacture of the laminated cores, the groove walls are provided with comparatively thick coatings that simultaneously serve as corrosion protection and give the grooves in the finished laminated core their final shape, which differs significantly from the groove shape in the plates (e.g. DE 196 20 222 01, DE 197 03 497 A1, DE 10 2004 021 740 A1). This type of manufacture is advantageous to the extent that on the one hand, the actual sheet metal plate can easily be provided with essentially congruent teeth and grooves and can therefore be manufactured in a way that generates a low amount of scrap, while on the other hand, it is possible to fix the windings in the grooves of the laminated core in a fashion similar to snap connections. This is true independent of whether the windings are inserted directly into the grooves or sleeves used for grounding purposes are placed into the grooves first (e.g. 196 20 222 C1). The disadvantage in this known embodiment of the laminated core, however, is the fact that after being manufactured, the laminated core requires an additional complex work step in which injection molding, pressure gelation, or the like is used to provide it with a plastic or corrosion-protection coating that determines the final groove shape.

From the above-cited prior art, it is clear that by means of stamping or the like, the sheet metal plates of the above-described stator packets can either be provided with groove shapes that facilitate the direct insertion of the windings, but result in the generation of a large amount of scrap or be provided with groove shapes that only generate a small amount of scrap, but must be provided with an additional coating that permits the windings to be inserted.

The technical object of the present invention, therefore, is to embody the stator packet of the generic type mentioned at the beginning so that the manufacture of the plates entails only a small amount of waste and even the manufacture of the plates by means of stamping or the like results in a final groove shape that facilitates insertion of windings and therefore does not require subsequent application of coatings that determine the groove shape.

This object is attained according to the invention with the defining characteristics of claim 1.

By means of the invention, a stator packet is created, which has grooves whose shape is determined solely during the manufacture of the plates by means of stamping or the like and is not determined by a subsequently applied plastic coating. In addition, the fact that only comparatively small wall sections are provided as bearing surfaces for the windings and the groove walls are otherwise embodied as centrally symmetrical, not only achieves the advantage of a low amount of stamping waste, it also permits the windings to be pressed into the grooves as before in a fashion similar to snap connections and secured in them without additional accessories. This significantly reduces the overall manufacturing cost for the stator packets.

Additional advantageous features of the invention ensue from the dependent claims.

The invention will be explained in greater detail below in connection with preferred exemplary embodiments and in conjunction with the accompanying drawings, whose depictions are shown in different scales.

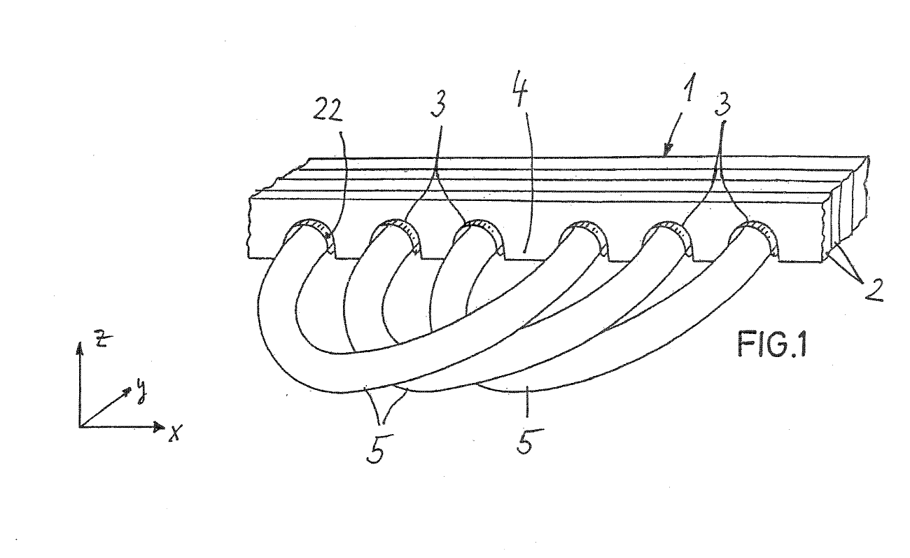

FIG. 1 is a schematic, perspective depiction of a known stator packet for a long-stator linear motor with a three-phase AC winding;

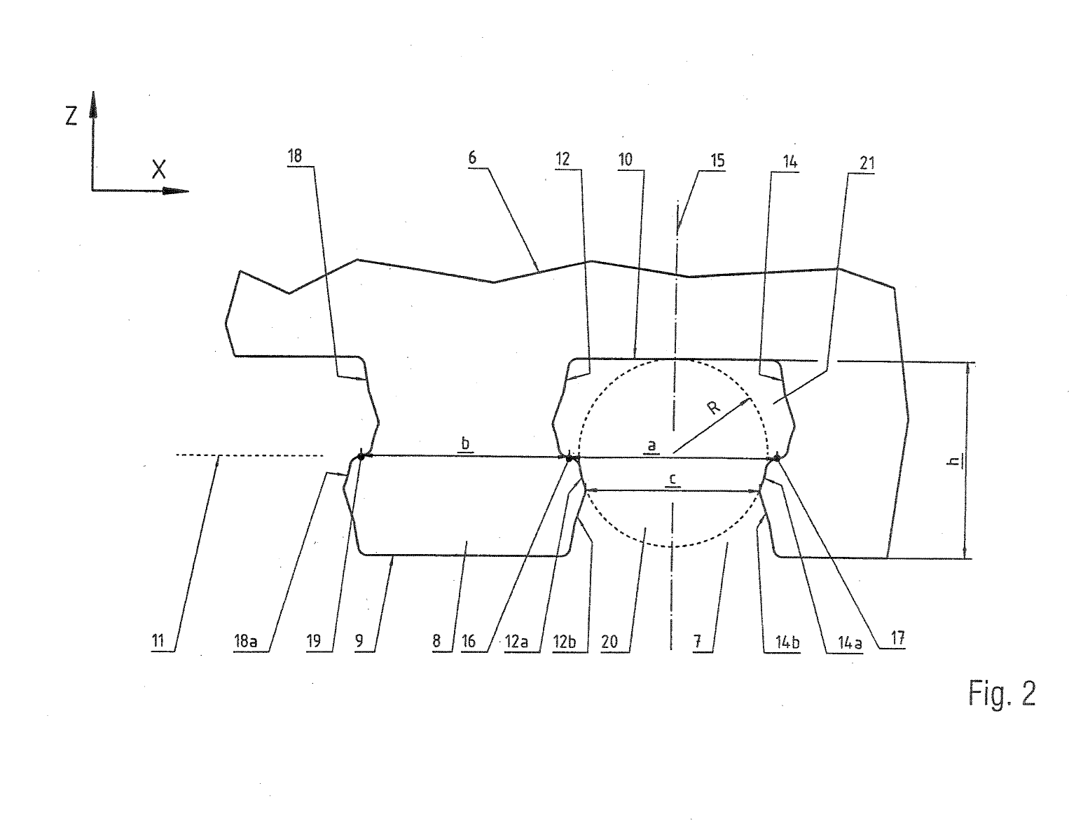

FIG. 2 schematically depicts the contours of one tooth and one groove of a plate according to the invention for a stator packet according to FIG. 1;

FIG. 3 shows a view of the groove corresponding to the one in FIG. 2, with a sleeve inserted into it for grounding purposes;

FIG. 4 shows a view of the groove corresponding to the one in FIG. 3, with a winding additionally inserted into the sleeve;

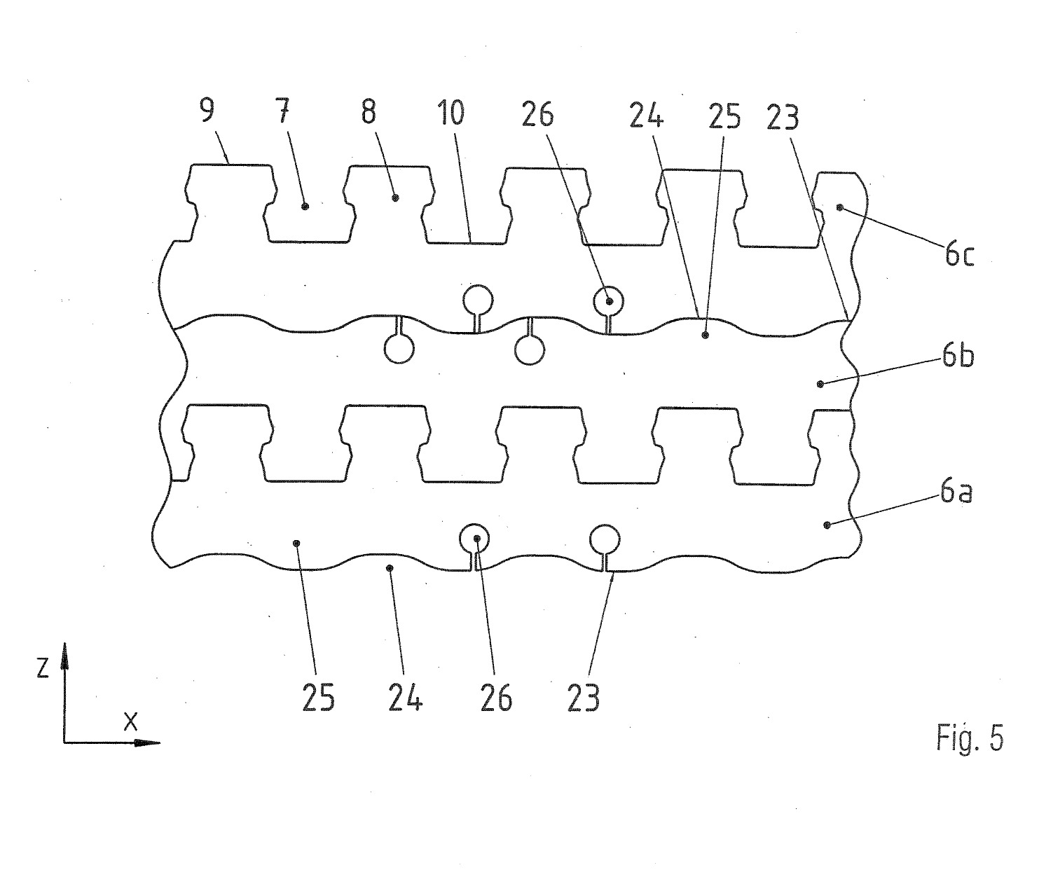

FIG. 5 is a schematic top view of three plates according to the invention, during their manufacture through stamping or the like;

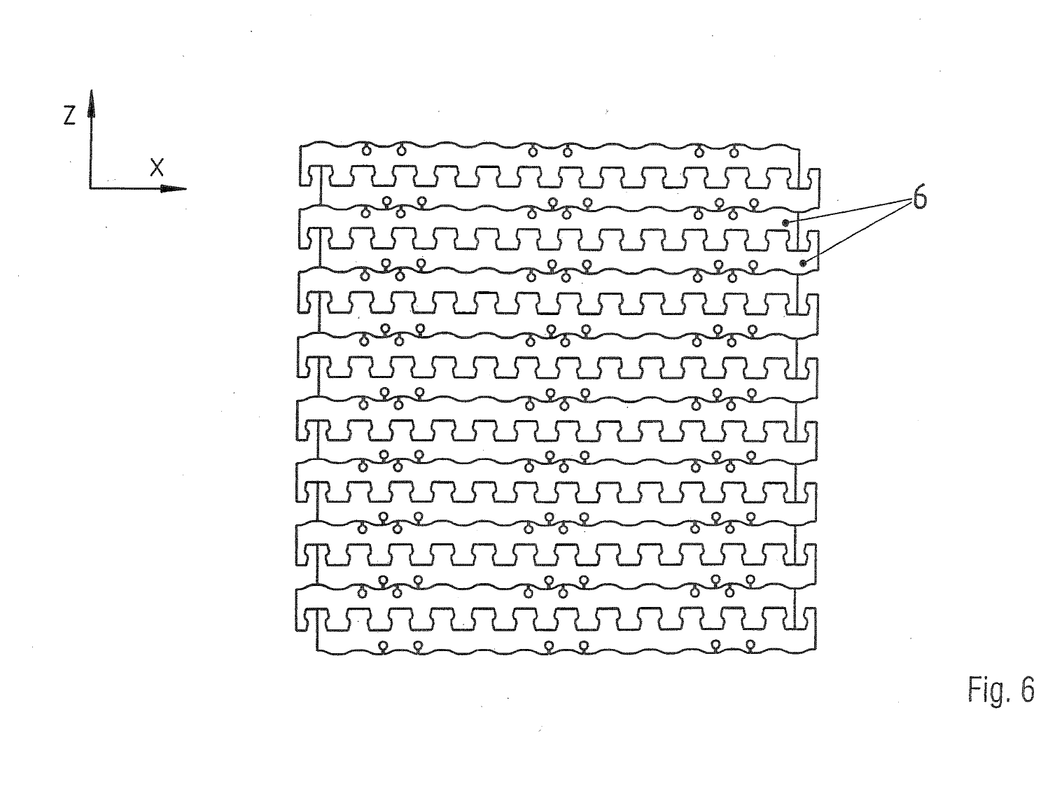

FIG. 6 shows a preferred cutting pattern for a plurality of plates embodied in accordance with FIGS. 2 through 5;

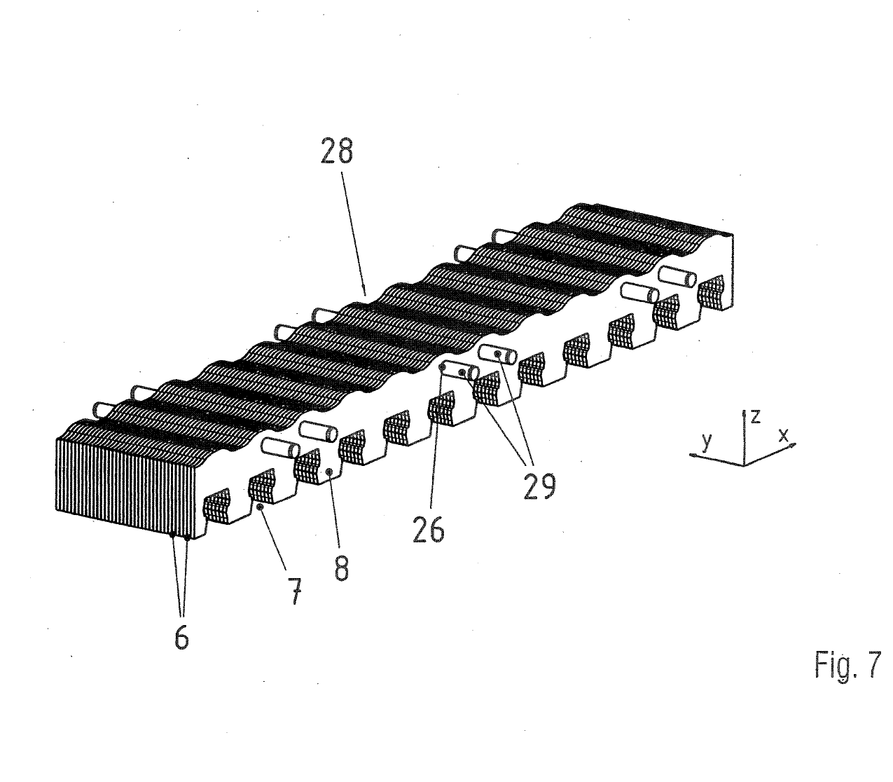

FIG. 7 is a perspective depiction of a stator packet according to the invention, which is manufactured out of the plates according to

FIGS. 2 through 5, with mounting rods provided for mounting it on the track of a magnetic levitation train;

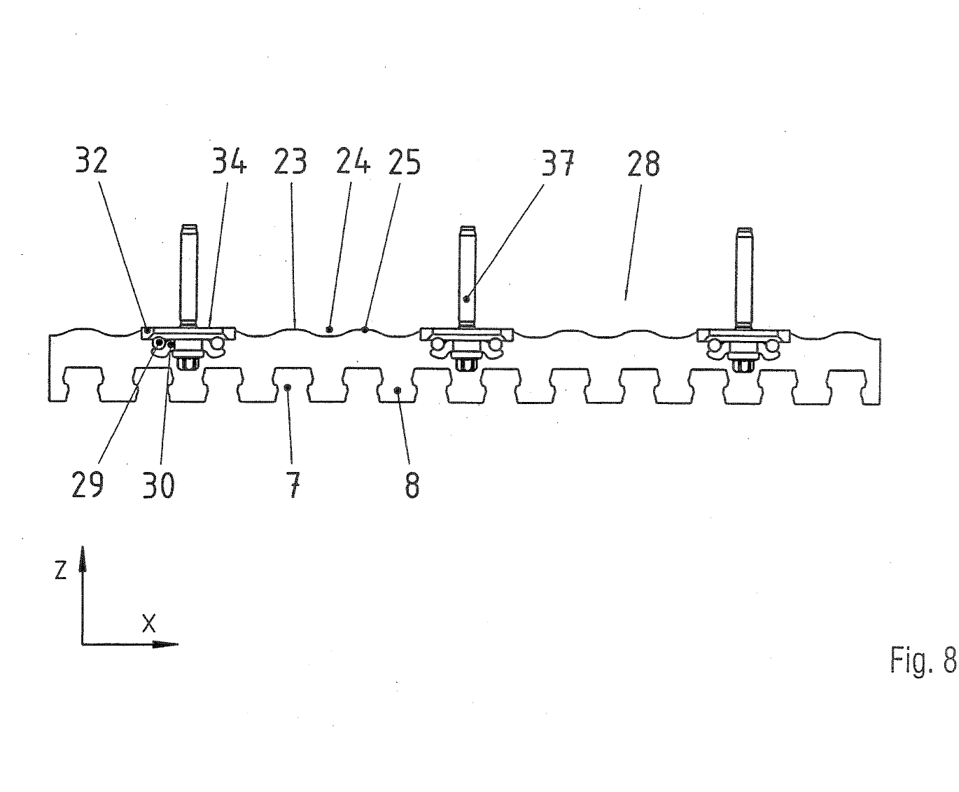

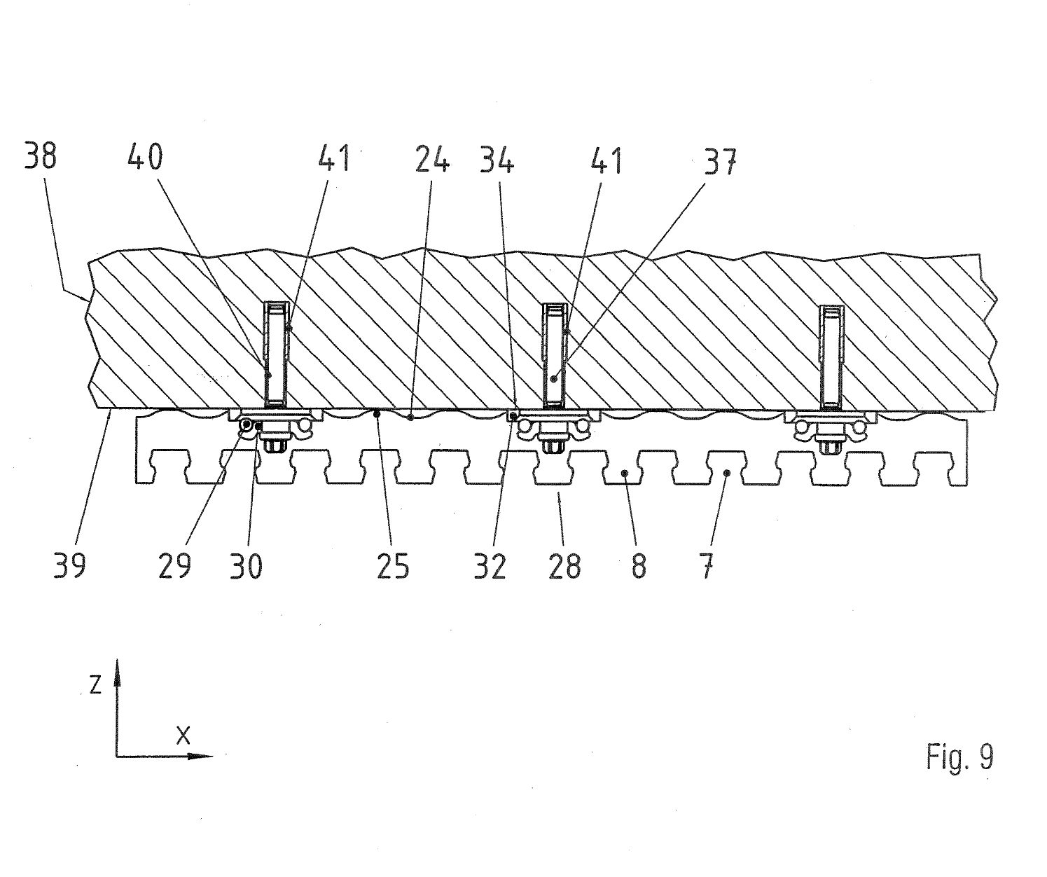

FIGS. 8 and 9 show a respective side view and longitudinal view of the stator packet according to FIG. 7, with additional fastening elements embodied for its installation;

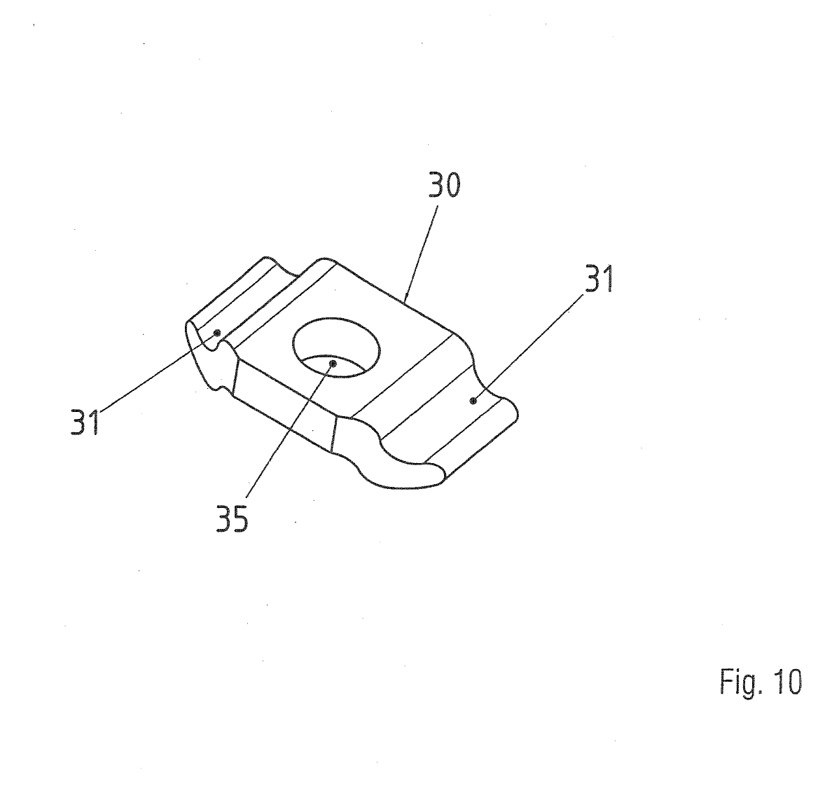

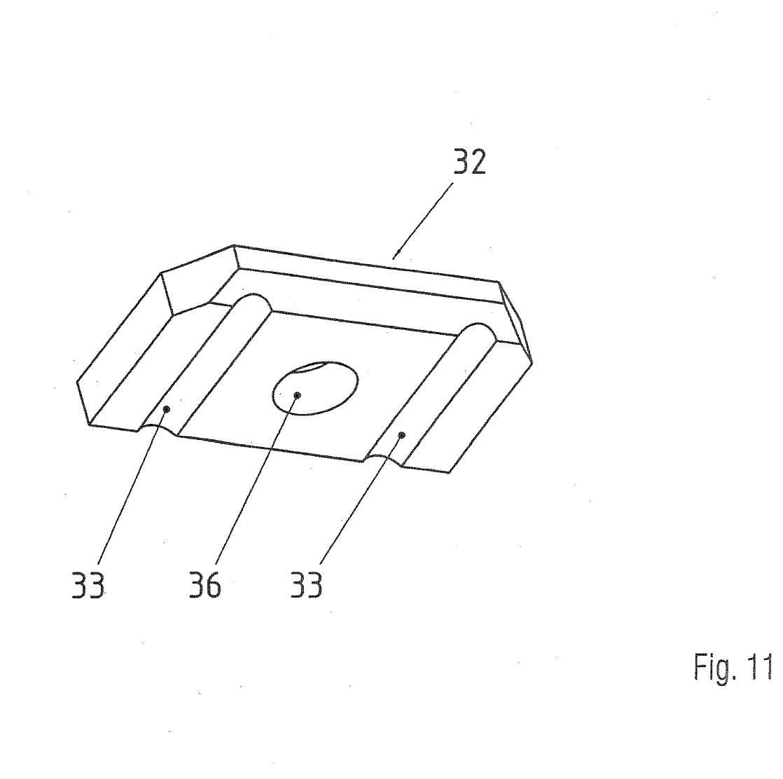

FIGS. 10 and 11 are perspective depictions of two fastening shims for the stator packet according to FIGS. 8 and 9;

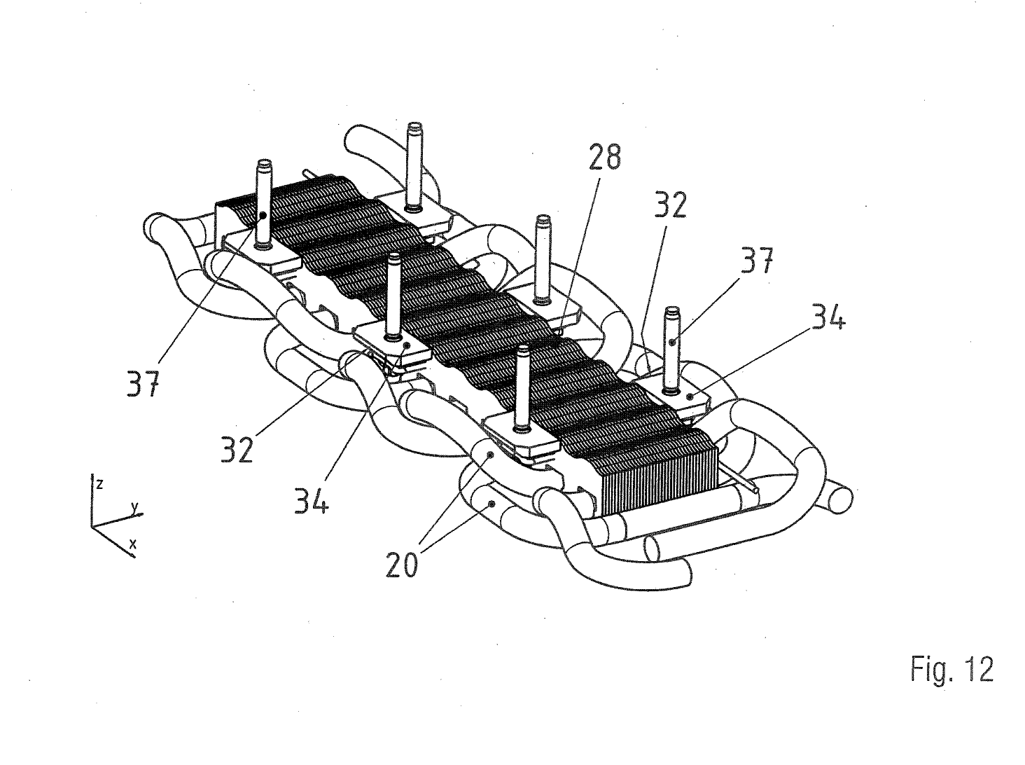

FIG. 12 is a perspective depiction of the stator pack according to FIGS. 8 and 9, including the inserted windings;

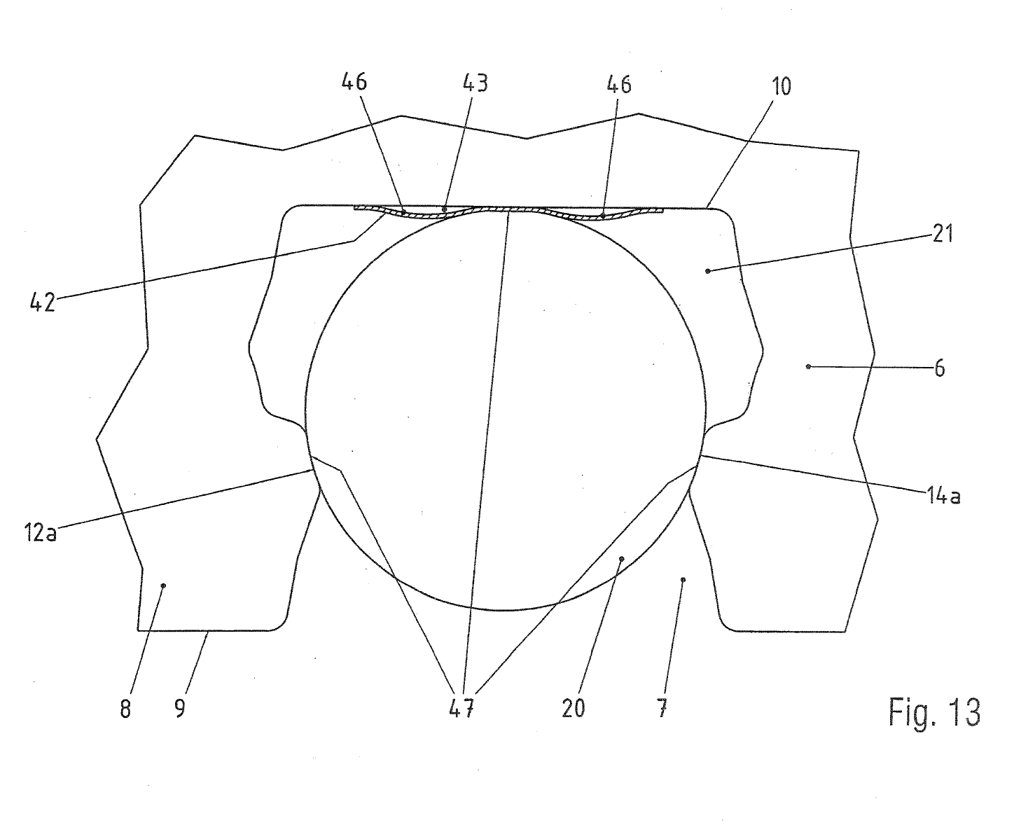

FIG. 13 is a schematic view corresponding to the one in FIG. 2, depicting the groove of a plate according to the invention, with a grounding strip inserted into the groove;

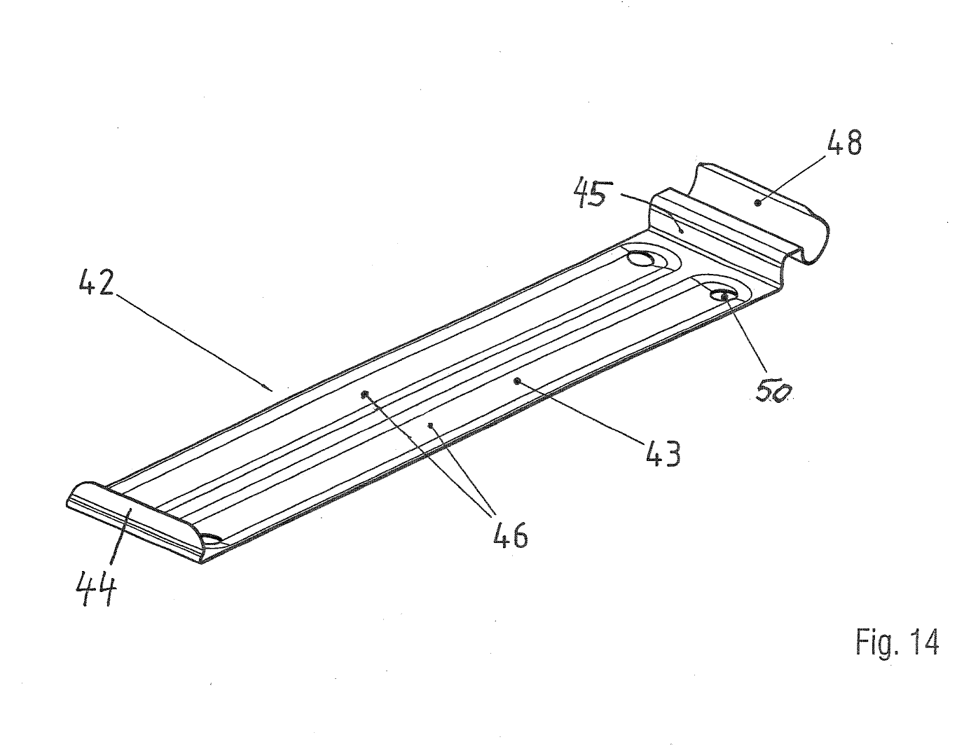

FIG. 14 is a perspective view showing only the grounding strip from FIG. 13; and

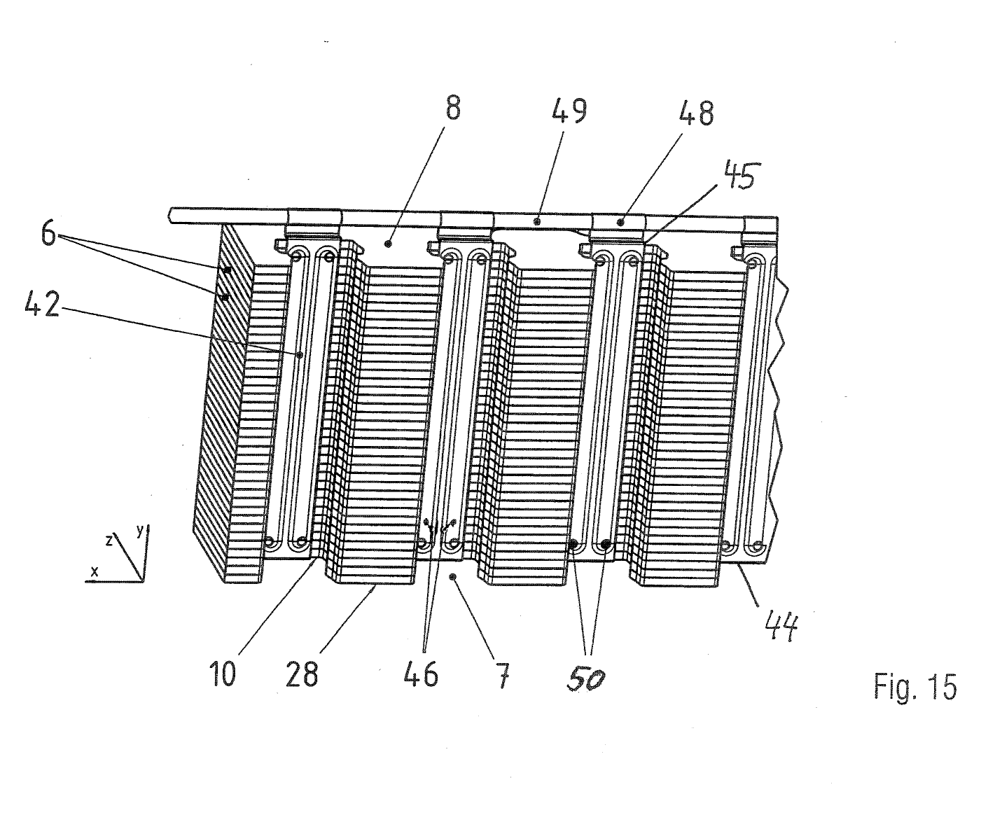

FIG. 15 is a perspective bottom view of a stator packet according to the invention, whose grooves are occupied by grounding strips from FIGS. 13 and 14.

FIG. 1 shows a section of a stator packet 1 for a long-stator linear motor. Stator packets 1 of this kind are mounted, for example, to a track, not shown, for magnetic levitation trains and are situated one after another in a travel direction that corresponds to the x axis of an imaginary Cartesian coordinate system. Each stator packet 1 is composed of a laminated core that is assembled from a plurality of plates 2 that are manufactured out of a ferromagnetic material and attached to one another for example by means of gluing. In the exemplary embodiment, the undersides of the plates have a plurality of grooves and teeth that are arranged so that they alternate with one another in the travel direction x with a predetermined spacing pattern. The grooves and teeth of the individual plates 2 are aligned with one another in the y direction of the imaginary coordinate system so that the stator packet 2 has grooves 3 and teeth 4 extending all the way through in the y direction oriented perpendicular to the travel direction; windings 5 of a three-phase AC system are situated in the grooves 3 in the way shown in FIG. 1. The windings 5 are composed of insulated electrical lines with casings composed of a material with a low electrical conductivity, e.g. a flexible rubber mixture that can be elastically compressed slightly in the radial direction.

Stator packets 1 of this type are generally known from the prior art references cited at the beginning and therefore do not need to be explained in detail to the person skilled in the art.

FIG. 2 shows part of an individual plate 6 according to the invention, with a groove 7 and a tooth 8 delimiting it on the right and left sides. The groove 7 is open toward an underside of the plates 2 formed by the bases 9 of the teeth 8 and is delimited at the opposite end by a groove bottom 10. A center plane 11 depicted with a dashed line extends in the middle between the bases 9 and the groove bottom 10, perpendicular to the plane of the drawing and is common to all of the grooves 7 and teeth 8 of the plate 6, spaced apart from both the bases 9 and the groove bottom 10 by a distance h/2, where h is the height of the grooves 7 and teeth 8, and extends parallel to the x-y plane of the imaginary coordinate system.

The groove 7 is also delimited by side walls 12 and 14 that are situated mirror-symmetrical to a symmetry plane 15 that is likewise situated perpendicular to the plane of the drawing and perpendicular to the center plane 11, extends parallel to the y-z plane of the imaginary coordinate system, and extends through the center of the groove 7. In addition, the side walls 12 and 14 are centrally symmetrical to the lines 16 and 17 that lie on the center plane 11, are situated perpendicular to the plane of the drawing, and constitute parallels to the y axis of the imaginary coordinate system. Consequently if the side walls 12, 14 are rotated 180° around the lines 16 and 17 associated with them, then they are projected onto themselves.

The same is true for the tooth 8 depicted on the left in FIG. 2, which is delimited on the one side by the side wall 12 of the groove 7 and on the other side by a side wall 18 that is situated mirror-symmetrical thereto, which simultaneously constitutes a side wall of the additional groove 7 situated further to the left in FIG. 2. In addition, the center plane 11 intersects not only the side walls 12 and 14, but also the side wall 18 in a line 19 situated parallel to the y axis, to which line the side wall 18 is centrally symmetrical in the same way as the side walls 12 and 14 are to the lines 16 and 17.

A distance a measured in the x direction between the lines 16 and 17 corresponds exactly to a distance b in the x direction between the lines 16 and 19. Because of this embodiment, the tooth 8 is congruent to the groove 7 and is merely rotated by 180° relative to it around a connecting line between the lines 16 and 19. In other words, if the tooth 8 were rotated by 180°, it would fit exactly in the groove 7.

The side walls 12 and 14 of the groove 7 are embodied so that in a region situated between the bases 9 and the center plane 11, they have a region with a smallest distance c that is smaller than the distance a. Between this region and the center plane 11, the side walls 12 and 14 are provided with sections functioning as bearing surfaces 12a, 14a that preferably have a circular or cylindrical curvature. The radius of these bearing surfaces 12a, 14a extending from the symmetry plane 15 essentially corresponds to the radius R of a winding 20 depicted with dashed lines in FIG. 2, which has the same function as the winding 5 in FIG. 1. By contrast, the distance c is somewhat smaller than the diameter of the winding 20 and in particular, is selected to be of a size that permits the winding 20 to be pressed into the groove 7 from beneath in FIG. 2 in a fashion similar to a snap connection with an elastic radial deformation until its lower half rests against the bearing surfaces 12a, 14a, is held against them without additional accessories, and is thus secured against falling out of the groove 7.

So that the winding 20 can be completely accommodated in the groove 7, the cross-section of the groove 7—starting from the region with the smallest distance c—widens out in the direction toward the groove bottom 10 so that when the winding 20 is in the inserted state, there is a free space 21 between it and the side walls 12, 14.

To facilitate the pressing of the winding 20 into the groove 7, on the side of the region with the smallest distance c oriented toward the bases 9, the side walls 12, 14 have respective guide surfaces 12b, 14b that enclose angles with the bearing surfaces 12a, 14a such that the groove 7, starting from the region with the smallest distance c, gradually widens out not only in the direction toward the groove bottom 10, but also in the opposite direction. As a result, the guide surfaces 12b, 14b constitute insertion bevels for the winding 20 that extend away from each other in a wedge shape.

When the windings 20 are inserted into the grooves 7 or more precisely stated, the grooves 3 formed by all of the plates 6 of a stator packet 2 (FIG. 1), they are not usually inserted alone, but rather together with intrinsically known sleeves 22 (FIGS. 3 and 4) provided for grounding purposes (e.g. see DE 196 20 222 C2, FIGS. 2 and 5). For this reason, the angle between the bearing surfaces 12a, 14a and the guide surfaces 12b, 14b is preferably selected in accordance with the shape of these sleeves 22. As depicted in FIGS. 3 and 4, such sleeves 22 are essentially cylindrically shaped in an upper region, but in a lower region, are provided with bent lower edges 22a. In addition, they are preferably embodied so that they are first pressed into the grooves 7 with elastic, radial deformation and then, in the free space 21, can elastically expand again in the radial direction so that they rest with the cylindrical part against the bearing surfaces 12a, 14a on the one hand, while on the other hand, their bent lower edges 22a rest against the guide surfaces 12b, 14b. As a result, the sleeves 22 can be firmly anchored in the grooves 7 (FIG. 3). Then the windings 20, whose outer diameter essentially corresponds to the inner diameter of the cylindrical parts of the sleeves 22, are pressed into the sleeves 22, which are likewise open toward the open end of the grooves 7, in the way shown in FIG. 4, as a result of which the windings 20 are fixed in place in the grooves 7 in the same way as when they are pressed into the grooves 7 without the sleeves 22 in accordance with FIG. 2. This is true in particular because in the installed state, the windings 20 are encompassed by the sleeves 22 along a circumference section comprising more than 180°, as clearly shown in FIG. 4.

In a region that is situated on the side of the guide surfaces 12b, 14b oriented away from the center plane 11, the groove 7 continuously widens out in accordance with FIGS. 2 through 4 to the bases 9 of the adjacent teeth 8 until its side walls 12 and 14 transition into the bases 9 along small radii. Otherwise, the side walls 12, 14 on both sides of the lines 16, 17 each have short transition sections. On the side of the center plane 11 oriented toward the groove bottom 10, the shape of the side walls 12, 14 until the transition into the groove bottom 10 is then produced automatically based on the above-described central symmetry to the lines 16 and 17.

Otherwise, it is clear that on the one hand, all of the grooves 7 and teeth 8 of one of the plates 6 and on the other hand, all of the plates 6 that constitute a stator packet 2 according to FIG. 1, are embodied in the same way. The only exception is the teeth situated at the end of a stator packet 1, which are as a rule only half the size of the teeth 8.

FIG. 5 schematically depicts additional details of the plates according to the invention, several grooves 7 and bases 8 of which are shown here. In particular, FIG. 5 shows a cutting pattern obtained for example by stamping a sheet metal strip or coil, which clearly shows that the respective teeth 8 of a first plate (e.g. 6a) fit precisely into the grooves 7 of the next plate (e.g. 6b) in the coil; the plate 6b is rotated by 180° relative to the plate 6a. There is thus no sheet metal waste in the region of the teeth 8 and grooves 7.

On their sides opposite from the bases 9, the plates 6 each have a respective spine 23. In a modification of the invention, these spines 23 are provided with cutouts 24 and ridges 25 that alternate in the x direction and are congruent to each other analogous to the grooves 7 and teeth 8. As a result, when two plates (e.g. 6b and 6c in FIG. 5) rest with their spines 23 against each other, the ridges 25 of the one plate (e.g. 6b) fit precisely into the cutouts 24 of the next plate (e.g. 6c) in the coil and vice versa. As is clear from FIG. 5, no sheet metal waste is generated by the stamping in the region of the spines 23 either.

With the plates according to the invention, sheet metal waste occurs essentially only when, in an exemplary embodiment of the plates 6 according to the invention considered to be the best up to now, the spines 23 are provided with holes 26 at selected locations, preferably situated in the region of selected ridges 25. These holes 26 are used, as explained below, to fasten completed stator packets to the track of a magnetic levitation train.

Due to the above-described embodiment of the plates 6, they are preferably manufactured using the cutting pattern shown in FIG. 6. In connection with a plurality of plates 6, FIG. 6 shows that these plates are provided with alternating types of denticulation, on the one hand in the form of their alternating grooves 7 and teeth 8 and on the other hand in the form of their cutouts 24 and ridges 25. When such a cutting pattern is used, eighteen sheet metal plates 6—instead of the sixteen that were previously possible—can be accommodated in a sheet metal strip of a given length. In this connection, it is clear that in lieu of being stamped, the plates 6 can also be cut out from a sheet metal strip by means of other methods, in particular procedures using lasers, water jets, cutting wheels, or the like.

Otherwise, the side walls 12, 14 of the grooves 7 are provided with a thin corrosion protection layer composed of a suitable varnish or the like, for example a 2-component epoxy resin-based varnish. This corrosion protection layer is suitably attached in that initially, a plurality of plates 6 are attached to one another by means of gluing or the like in order to form a stator packet 28 (FIG. 7) and such that the stator packet 28 is then covered with varnish over its entire outside surface, e.g. by means of a dipping or spraying process. At 300 μm, for example, the varnish layer according to the invention is so thin that it does not change the groove and tooth shapes described in conjunction with FIGS. 2 through 5.

As FIG. 7 also shows, the holes 26 serve to accommodate mounting rods 29. After the assembly of the stator packet 28, the mounting rods 29 are inserted into the mutually aligned holes 26 (FIG. 5) of the plates 6 and then fixed in place in the holes 26 by means of frictional engagement, gluing, or the like. The mounting rods 29 have a length such that their ends protrude slightly from both sides of the stator packet 28. The mounting rods 29 extending in the y direction are preferably inserted into position before the varnishing process in order to also coat its freely extending ends with a thin corrosion protection layer.

FIGS. 8 through 12 show a particularly preferred exemplary embodiment for the assembly of the stator packets 28 according to FIG. 7. To this end, shims 30 are placed from beneath against the end sections of two adjacent mounting rods 29 suitably protruding from the same ridge 25 as each other and have receiving troughs 31 on their top surface, spaced apart by the same distance as the mounting rods 29 (FIG. 10), which partially accommodate the ends of the mounting rods 29, as depicted in FIGS. 8 and 9. Additional shims 32 provided with corresponding receiving troughs 33 on their undersides, as shown in FIG. 11, are placed from above onto the ends of the mounting rods 29. The top surfaces of these shims 32 protrude slightly beyond the ridges 25 of the plates 6 in the z direction, respectively constituting a first, preferably planar, mounting surface 34 (FIGS. 8 and 12). In addition, both the shims 30 and the additional shims 32 have respective center holes 35, 36 (FIGS. 10 and 11) for fastening screws 37 (FIGS. 8 and 9).

The stator packets 28 are fastened to a track 38 manufactured of concrete and/or steel for a magnetic levitation train, in particular are fastened, for example, to a cantilever arm or other part of a track support, preferably in the way shown in FIGS. 8, 9, and 12. To this end, the first mounting surfaces 34 are placed against second mounting surfaces 39 associated with them, which are embodied, for example, on the underside of the track 38. These second, preferably likewise planar mounting surfaces 39 are embodied in an intrinsically known fashion, entirely or partially in accordance with the selected route, for example in that the undersides of the track 38 are machined in a material-removing, milling, or grinding fashion with the aid of computer-controlled tools such as milling tools. Alternatively, the second mounting surfaces 39 can also be formed onto projections of the track 38 that are spaced apart in the x direction and possibly also in the y direction. This would achieve the advantage that the track 38 could be assembled from a multitude of track supports or their cantilever arms that are composed of uniform (identical) blanks whose projections are then individually machined in order to produce the second mounting surfaces 39.

After the first mounting surfaces 34 are placed against the second mounting surfaces 39, the mounting rods 29 of a stator packet 28 are inserted into the receiving troughs of the shims 32, then the shims 30 in FIGS. 8, 9, and 12 are placed against the mounting rods 29 from beneath, the fastening screws 37 are inserted from beneath into the center holes 35, 36 of the shims 30, 32 and then into associated bores 40 suitably extending in the z direction in the track 38, and screwed into threaded inserts 41 until their heads rest against the undersides of the shims 30, thus securely fastening the stator packets 28 to the track 38 by means of the shims 30 and 32. The threaded inserts 41 are provided at the upper ends of the bores 40 and are for example welded to the track 38 if it is made of steel or in the case of concrete tracks, are cast into the concrete and optionally welded to its reinforcing elements.

The above-described fastening approach has the advantage of no longer requiring the previously customary, comparatively expensive crossbars (e.g. DE 197 03 497 A1, FIG. 15).

Otherwise, FIG. 12 shows a view analogous to the one in FIG. 1 of the windings 20 inserted into the grooves of the stator packet 28.

Whereas before, the sleeves 22 according to FIGS. 3 and 4 were consistently used for grounding the casings of the windings 20, a preferred exemplary embodiment of the invention proposes using only grounding strips 42 according to FIGS. 13 through 15 for this purpose. According to an exemplary embodiment currently considered to be the best, such a grounding strip 42 is composed of a flat, rectangular sheet metal strip 43 (FIG. 14) that has a length, which essentially corresponds to the width of the stator packet 28 measured in the y direction (FIG. 15), and a width that, measured in the x direction, is less than or at most exactly equal to the width of the groove bottom 10 of the plates 6 (FIG. 13).

At its far ends, the sheet metal strip 43 has protrusions 44 and 45 formed by bends that permit it to be fastened to the stator packet 28 in a sprung fashion like a clip connection in the way shown in FIG. 15 when it is placed against the groove bottom 10. The dimensions of the grooves 7, the windings 20, and the grounding strip 42 are otherwise matched to one another so that the winding 20, when it is resting against the bearing surfaces 12a, 14a and is otherwise situated with its upper half in the free space 21, simultaneously rests against the sheet metal strip 43 with its casing section situated diametrically opposite from the free groove opening and its casing is therefore connected to the grounding strip 42 in a way that is very electrically conductive.

The electrically conductive contact between the winding casing and the grounding strip 42 can be improved by providing the sheet metal strip 43 with preferably at least two embossed reinforcing corrugations 46 that are raised significantly in the direction toward the groove 7. In the installed state according to FIG. 13, the side portions of these reinforcing corrugations 46 are pressed slightly into the casing of the winding 20, thus improving the electrical contact, and are situated to either side of the apex line of the winding 20, as a result of which after the insertion of the winding 20, it keeps the grounding strip 42 centered in the groove 7 and secured in position. On the one hand, this yields three bearing surfaces 47 (FIG. 13) between which the winding 20 is clamped and securely held. On the other hand, the grounding strip 42 also cannot easily slip sideways, i.e. in the x direction, during operation so that there is no risk of damage to the insulation at the edges of the groove bottom 10.

To connect the grounding strips 42 to the ground potential, a connecting element 48 (FIG. 14) embodied in the shape of a shell or the like is respectively formed onto the protrusion 45 at the end of each grounding strip 42 that protrudes from the stator packets 28. A line 49 that is connected to the ground potential is inserted into this connecting element 48, as shown in FIG. 15. The grounding strip 42 and the line 49 are suitably composed of a very electrically conductive, corrosion-resistant material such as stainless steel.

Finally, the grounding strips 42 are provided with respective holes 50 in the region of the reinforcing corrugations 46. These holes serve to permit drainage of spray or condensate that could collect between the stator packet 38 and the grounding strips 42.

If the features shown in FIGS. 2, 9, and 13 are combined, this yields a stator packet 28, which—in terms of design, assembly, and grounding—is significantly less expensive to manufacture and assemble than conventional designs, with no loss in functionality.

The invention is not limited to the exemplary embodiments described above, which can be modified in numerous ways. This is particularly true of the shape of the teeth and grooves shown in FIG. 2, which can undergo certain modifications in terms of their size and curvature. The same is true of the spines 23 of the plates 6, which could also be embodied as planar, i.e. without the cutouts 24 and ridges 25. In addition, the assembly of the above-described stator packet 28 can take place in a way other than that described above and the grounding strip 42 can be embodied in a way other than that described above, e.g. with regard to the number and position of the reinforcing corrugations 46. Furthermore, the holes 50 can be replaced with small drainage conduits that are routed to the outside by the reinforcing corrugations 46. It would also be possible to provide the grounding strip 42 with a connecting element 48 at both ends and to connect each of them to a respective grounding line 49. In addition, it is possible to insert respective thin films as needed between the bearing surfaces 12, 14a, and 18a and the windings 20 in order to counteract wear on the varnish coating due to vibrations of the windings 20 occurring during operation. Finally, it goes without saying that the various features can also be used in combinations other than those described and depicted here.

What is claimed is:

1. A stator packet for a long-stator linear motor, having a laminated core, which is composed of a plurality of ferromagnetic plates (6) that have teeth (8) arranged one after another, alternating in a predetermined spacing pattern, and have grooves (7) which are open toward an outside, which are embodied to accommodate AC windings (20), are provided with a common center plane (11), and are delimited by side walls (12, 14) situated opposite each other, which side walls (12, 14), in a region situated to the outside of the center plane (11), have a smallest distance (c) and starting from there toward the inside and outside, have a gradually widening distance from each other and are provided with a thin corrosion protection layer that does not significantly change the shape of the teeth and grooves, so that it is possible for the windings (20) to be pressed into the grooves (7) in a fashion similar to snap connections and then secured in them without additional accessories,
wherein the teeth (8) and grooves (7) are embodied as essentially congruent in that the side walls (12, 14, 18) are provided with cylindrical sections extending from the region with the smallest distance (c) to shortly before the center plane (11) and embodied in the form of bearing surfaces (12a, 14a, 18a) for the windings (20) and are embodied overall as centrally symmetrical around lines (16, 17, 19) lying in the center plane (11).

2. The stator packet as recited in claim 1,
wherein between the center plane (11) and a groove bottom (10), the plates (6) each have a free space (21) that is retained even after insertion of a winding (20).

3. The stator packet as recited in claim 1,
wherein between the region with the smallest distance (c) and a plane defined by bases (9) of the teeth (8), the side walls (12, 14) extend away from each other in a wedge shape like insertion bevels for the windings (20).

4. The stator packet as recited in claim 1,
wherein it is provided with sleeves (22) for grounding purposes, which fit into the grooves (7), are supported against bearing surfaces (12a, 14a), and accommodate the windings (20).

5. The stator packet as recited in one of claims 1,
wherein it is provided with windings (20) that are inserted into the grooves (7) and that are supported directly against the bearing surfaces (12a, 14a) without interposed sleeves (22).

6. The stator packet as recited in claim 5,
wherein it is provided with grounding strips (42) situated at the groove bottoms (10) of the plates (6).

7. The stator packet as recited in claim 6,
wherein the grounding bands (42) are provided with reinforcing corrugations (46) that are raised significantly in the direction toward the inserted windings (20).

8. The stator packet as recited in claim 6,
wherein the grounding bands (42) each have an end section that protrudes from the stator packet (28) and is provided with a connecting element (48) for a grounding line (49).

9. The stator packet as recited in claim 1,
wherein the plates (6) are provided with spines (23) that have an alternating arrangement of congruent cutouts (24) and ridges (25).

10. The stator packet as recited in claim 9,
wherein the spines (23) are provided at selected locations with holes (26) designed to accommodate mounting rods (29).

11. The stator packet as recited in claim 10,
wherein it is provided with mounting rods (29) that are inserted into the holes (26) and protrude from the laminated core at both ends, which are associated with shims (30) provided with center holes (35) to accommodate fastening screws (37) for attachment to the track (38) of a magnetic levitation train.

12. The stator packet as recited in claim 11,
wherein the mounting rods (29) are associated with additional shims (32) that have mounting surfaces (34) embodied for contact with the track (38).
